(19) United States
(12) Patent Application Publication
(10) Pub. No.: US 2004/0075337 A1
(43) Pub. Date: Apr. 22, 2004

(54) Method for controlling an electrohydraulic braking system

(76) Inventors: Bernhard Giers, Frankfurt (DE); Robert Schmidt, Rennerod (DE); Lother Sportnitz, Frankfurt (DE); Georg Fachinger, Limburg (Lahn) (DE); Andreas Klein, Bad Homburg (DE); Stefan Stolzl, Weinheim (DE); Andreas Kohl, Mainz (DE); Ralf Junge, Steinbach (DE); Timo Gurzawski, Mainhausen (DE); Thorsten Ulrich, Gernsheim (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/432,796

(22) PCT Filed: Nov. 23, 2001
(86) PCT No.: PCT/EP01/13672

(30) Foreign Application Priority Data
Nov. 27, 2000 (DE) 10058797.6

(51) Int. Cl. B60T 13/66

(52) U.S. Cl. 303/20; 188/122

(57) ABSTRACT

The present invention relates to methods for controlling an electrohydraulic brake system which represent types of emergency braking operating modes being actuated when various malfunctions occur, such as a malfunction caused by a mechanical fault of one of the pressure control valves, of a pressure sensor used to determine the wheel brake pressures, a high-pressure accumulator serving a an auxiliary-pressure source or a pump cooperating with the high-pressure accumulator, a separating valve closing the connections between the wheel brakes and an emergency pressure generator or master brake cylinder as well as when a loss in pressure occurs in any of the wheel brakes associated with the front or the rear axle.

### TECHNICAL FIELD

The present invention generally relates to a method for controlling an electrohydraulic braking system for motor vehicles and more particularly relates to a method for controlling an electrohydraulic braking system for motor vehicles which is controllable in a ‘brake-by-wire’ operating mode.

### BACKGROUND OF THE INVENTION

German patent application DE 198 07 369 A1 discloses a brake system of this type. The mentioned application discloses fallback operating modes that are initiated especially in the presence of serious faults of the brake system, a fault in the acquisition of the braking request or a fault concerning only one wheel of a vehicle axle. During operation of a brake system of this type, however, still further faults may occur which are not taken into consideration in the implementation of the state of the art method.

### BRIEF SUMMARY OF THE INVENTION

In view of the above, an object of the present invention is to disclose novel fallback operating modes enabling a safe operation of the electrohydraulic brake system when the above-mentioned faults occur.

This object is achieved according to a first method in that in the event of failure of a valve that is caused by a mechanical fault, the said valve controlling the wheel brake pressure in a wheel brake associated with a vehicle axle, or in the event of failure of a pressure sensor that is associated with a wheel brake of a vehicle axle, brake pressure control on this vehicle axle is carried out in the ‘brake-by-wire’ operating mode by means of an inlet valve and an outlet valve or by means of the pressure sensor associated with the other wheel brake of the vehicle axle, with the pressure compensating valve (balance valve) connected between the wheel brakes of the vehicle axle being open, while brake pressure control on the other vehicle axle is continued unchanged in the ‘brake-by-wire’ operating mode. It is imperative that the sensor error that causes malfunction is undoubtedly assignable to the pressure sensor.

The inlet and outlet valves are preferably designed as electromagnetically operable, normally closed proportional valves that remain closed upon failure of the electric actuation control.

In a second method of the invention, which is appropriate in particular for controlling a brake system that includes an auxiliary pressure source comprised of a hydraulic pump and a high-pressure accumulator, the hydraulic pump exclusively ensures the development of the wheel brake pressure on all wheels in the event of failure of the high-pressure accumulator.

According to a third method of the invention, which is also appropriate for controlling a brake system that includes an auxiliary pressure source comprised of a hydraulic pump and a high-pressure accumulator, provision is made that upon failure of the hydraulic pump the development of wheel brake pressure on all wheels is exclusively effected by the high-pressure accumulator.

A fourth method of the invention, which is appropriate for controlling a brake system that includes a master brake cylinder operable by means of a brake pedal and to which the wheel brakes are connected by the intermediary of at least one separating valve, arranges for brake pressure control on the front axle to be continued unchanged in the ‘brake-by-wire’ operating mode upon failure of the separating valve associated with the rear axle, while the wheel brakes associated with the rear axle are connected to the master brake cylinder.

In a fifth method of the invention which is also appropriate for controlling a brake system that includes a master brake cylinder operable by means of a brake pedal and to which the wheel brakes are connected by the intermediary of at least one separating valve, brake pressure control in a wheel brake of a vehicle axle as well as in the diagonally opposite wheel brake of the other vehicle axle is continued in the “brake-by-wire” operating mode upon failure of the separating valve associated with the front axle, with the pressure compensating valves connected between the wheels brake of both vehicle axles being closed, while the other diagonally opposite wheel brakes are connected to the master brake cylinder.

According to a sixth method of the type mentioned hereinabove, a loss in pressure fluid in a wheel brake associated with the rear axle will cause both wheel brakes associated with the rear axle to maintain their non-pressurized condition, while brake pressure control in the wheel brakes associated with the front axle is continued in the ‘brake-by-wire’ operating mode.

Alternatively, it is arranged for in a seventh method of the type mentioned hereinabove that a loss in pressure fluid in a wheel brake associated with the front axle will cause brake pressure control to be continued in the ‘brake-by-wire’ operating mode in the first wheel brake of a vehicle axle as well as in the diagonally opposite wheel brake of the other vehicle axle, with the two pressure compensating valves connected between the wheel brakes of the two vehicle axles being closed, while the other diagonally opposite wheel brakes are maintained in their non-pressurized condition.

### BRIEF DESCRIPTION OF THE DRAWINGS

FIG. 1 is a preferred embodiment of an electrohydraulic brake system wherein the methods of the present invention can be implemented.

FIGS. 2 to 9 are diagram views showing the individual operating modes of actuation of the wheel brakes when different faults occur.

### DETAILED DESCRIPTION OF THE PREFERRED EMBODIMENTS

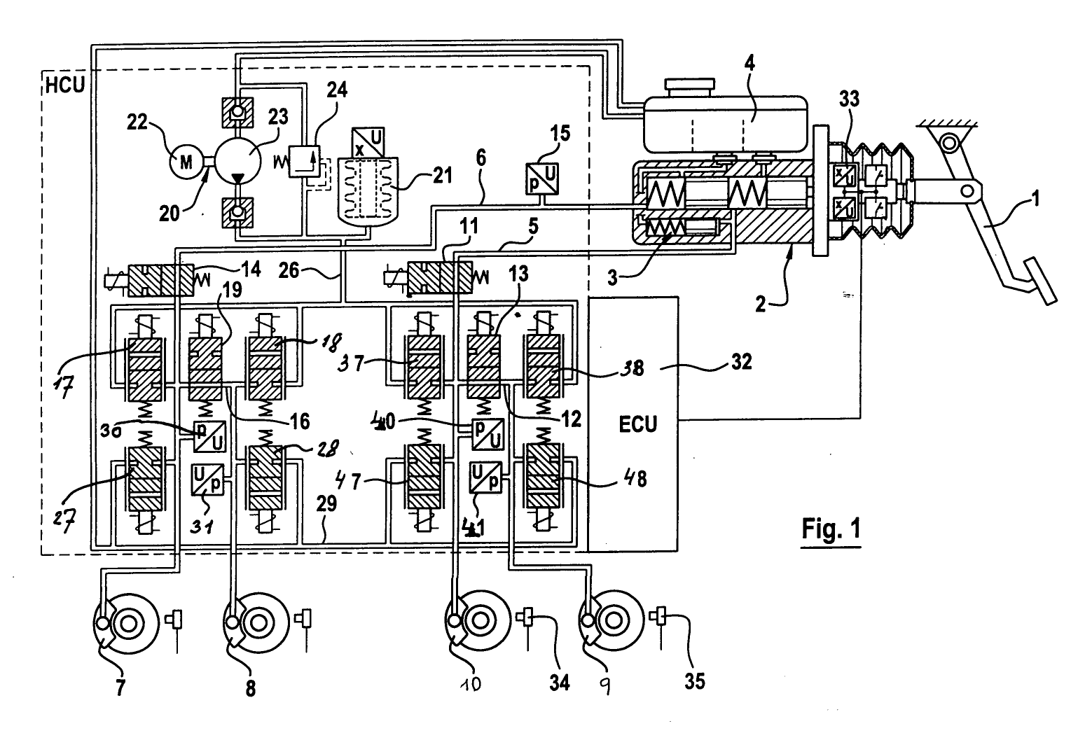

The electrohydraulic brake system illustrated in FIG. 1 includes a dual-circuit master brake cylinder or tandem master cylinder 2 that is operable by means of an actuating pedal 1, cooperates with a pedal travel simulator 3 and includes two pressure chambers isolated from one another and being in communication with a non-pressurized pressure fluid supply reservoir 4. Wheel brakes 9, 10 e.g. associated with the rear axle are connected to the first pressure chamber (primary pressure chamber) by means of a closable first hydraulic line 5. Line 5 is closed by means of a first separating valve 11, while in a line portion 12 between the wheel brakes 9, 10 an electromagnetically operable, preferably normally open (NO) pressure compensating valve 13 is inserted which enables brake pressure control on each individual wheel, if required.

The second pressure chamber of the master brake cylinder 2, to which a pressure sensor 15 can be connected, is connectable to the other pair of wheel brakes 7, 8 associated with the front axle by way of a second hydraulic line 6 closable by means of a second separating valve 14. Again, an electromagnetically operable, preferably normally open (NO) pressure compensating valve 19 is inserted into a line portion 16 disposed between the wheel brakes 7, 8.

As can be taken from the drawings in addition, a motor-and-pump assembly 20 with a high-pressure accumulator 21 is used as an auxiliary pressure source, said assembly, in turn, comprising a pump 23 driven by means of an electric motor 22 as well as a pressure limiting valve 24 connected in parallel to said pump 23. The suction side of the pump 23 is connected to the above-mentioned pressure fluid supply reservoir 4 by way of a pressure limiting valve 24. A pressure sensor (not shown) monitors the hydraulic pressure generated by the pump 23, or determines it by estimation.

A third hydraulic line 26 connects the high-pressure accumulator 21 to the inlet ports of two normally closed proportional valves 17, 18 of electromagnetic, analog operation, said valves being connected upstream of the wheel brakes 7 and 8 in the capacity of inlet valves, as well as to inlet ports of two further normally closed proportional valves 37, 38 of electromagnetic, analog operation which are connected upstream of the wheel brakes 10 and 9 in the capacity of inlet valves. Besides, the wheel brakes 7, 8 are connected to a fourth hydraulic line 29 by way of each one normally closed proportional valve or outlet valve 27, 28 of electromagnetic, analog operation and the wheel brakes 9, 10 are connected thereto by way of each one normally closed proportional valve or outlet valve 47, 48 of electromagnetic, analog operation. Said line 29 is in communication with the non-pressurized pressure fluid supply reservoir 4, on the other hand. The hydraulic pressure prevailing in the wheel brakes 7, 8 is determined by means of each one pressure sensor 30, 31, while the hydraulic pressure prevailing in the wheel brakes 10, 9 is determined by means of each one pressure sensor 40, 41.

An electronic control unit 32 is used for the joint actuation of the motor-and-pump assembly 20 as well as the electromagnetic valves 11, 13, 14, 17, 18, 19, 27, 28. The output signals of an actuating travel sensor 33 cooperating with the actuating pedal 1, and of the above-mentioned pressure sensor 15 are sent as input signals to said control unit 26, thereby permitting a detection of the driver's deceleration demand. However, other means such as a force sensor sensing the actuating force at the actuating pedal 1 may also be used for the detection of the driver's deceleration demand. As further input quantities, the output signals of the pressure sensors 30, 31, 40, 41 as well as the output signals of wheel sensors (only represented) representative of the speed of the vehicle are sent to the electronic control unit 32, with reference numerals 34, 35 being assigned to the wheel sensors associated with the wheel brakes 10, 9.

During normal operation or in the ‘brake-by-wire’ operating mode the brake system illustrated in FIG. 1 operates as follows: when the driver depresses the brake pedal, he/she senses a travel-responsive counterforce that is predetermined by the defined characteristics of the pedal simulator. When a request for braking is senses by means of the actuating travel sensor 33 and/or the pressure sensor 15, the separating valves 11, 14 will be closed and the wheel brakes 7 to 10 separated from the master brake cylinder 2. Pressure develops in the master brake cylinder 2 as a result of the actuating force applied to the brake pedal 1. The braking request of the driver is e.g. calculated as a nominal deceleration or as a nominal brake force from the signals of the actuating travel sensor 33 and/or the pressure sensor 15. The individual nominal wheel brake pressures are produced from this braking request. Depending on the driving condition and slip condition, these pressures are modified and adjusted by way of actuation of the pressure control valves 17, 18, 37, 38 as well as 27, 28, 47, 48. The current pressures at the wheel pressure sensors are taken into consideration with regard to each wheel brake 7 to 10 in the closed control circuit for the variance adjustment.

In the event of different nominal pressures in the left and right wheels of a vehicle axle, the pressure compensating valves 13, 19 are closed, and the predetermined nominal pressure is adjusted in each wheel brake by controlling the inlet and outlet valves with a view to adjusting the actual brake pressure to the nominal brake pressure. For pressure build-up in a wheel brake effected by means of the above-mentioned auxiliary pressure source 20, the inlet valve is energized until the desired nominal pressure develops in the wheel brake with the desired dynamics. Pressure reduction is achieved accordingly by energization of the outlet valve, with the pressure fluid flowing back into the pressure fluid supply reservoir 4 by way of the return line 29. Actuation of the pump 23 will occur when the accumulator pressure in the high-pressure accumulator 21 falls below a predetermined value.

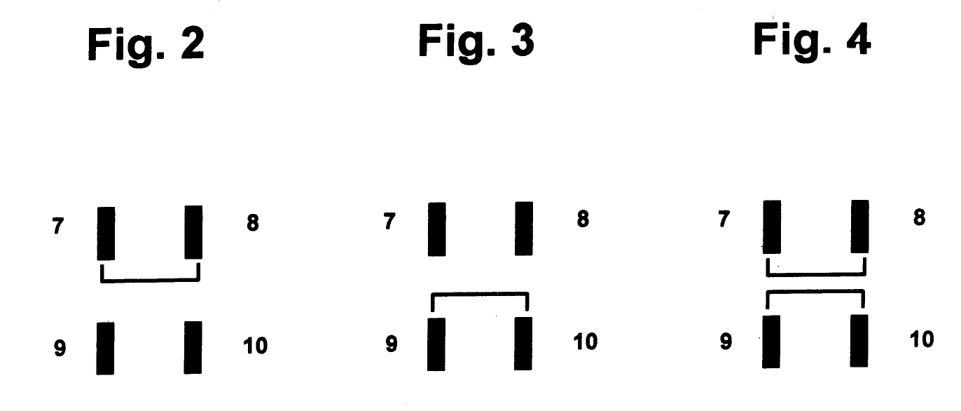

In the schematic illustrations shown in FIGS. 2 to 9 the ‘black’ square symbols refer to the wheel brakes actuated in the ‘brake-by-wire’ operating mode, the ‘black-and-white’ square symbols refer to the wheel brakes to which the hydraulic pressure produced by the master brake cylinder 2 is applied, and the ‘white’ square symbols refer to the wheel brakes adopting their non-pressurized condition.

When explaining the first type of actuation illustrated in FIG. 2 it shall be assumed that the inlet valve 17 associated to the front axle wheel brake 7 has failed due to a mechanical fault or that this inlet valve remained closed although actuated electrically. The connection between the two front-axle brakes 7 and 8 (only represented) means that the pressure compensating valve 19 must remain open so that pressure control on the brake 7 can take place by means of the valve pair 18, 28 associated with the other brake 8. Brake pressure control on the rear axle is continued unchanged in the ‘brake-by-wire’ operating mode. Corresponding provisions are of course taken both in the event of failure of a pressure control valve 37, 38, 47, 48 (FIG. 3) associated with the wheel brakes 10, 9 of the rear axle and in the event of each one pressure control valve (FIG. 4) associated with the wheel brakes of the front and the rear axle. Also, the described fallback operating mode is introduced not only upon failure of one of the pressure control valves 17, 27, 18, 28 but also upon failure of one of the pressure sensors 30, 31, 40, 41. In the last mentioned case, brake pressure control will be executed respectively with the non-failing pressure sensor associated with the other wheel brake.

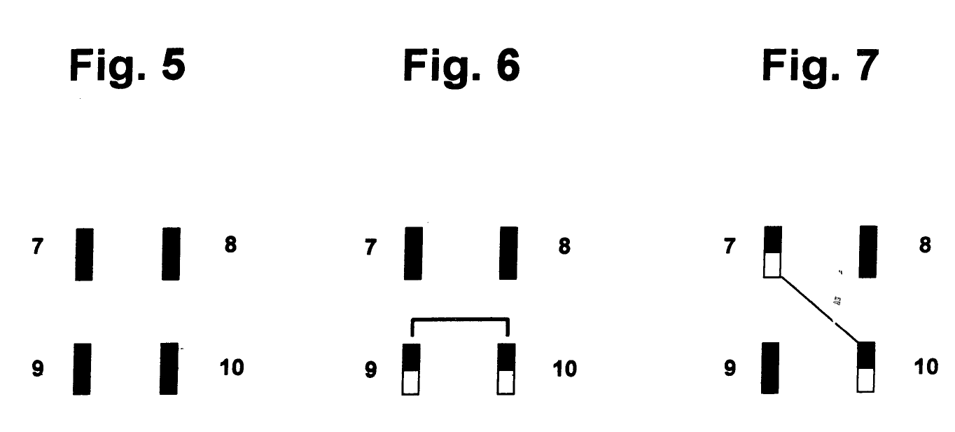

The second type of actuation briefly explained with respect to FIG. 5 is initiated if either the motor-and-pump assembly 20 or the high-pressure accumulator 21 fails. In the first-mentioned case, brake pressure control will be carried out in the ‘brake-by-wire’ operating mode on both vehicle axles exclusively by means of the pressure provided by the high-pressure accumulator 21 until the latter's exhaustion. In contrast thereto, brake pressure control will be performed in the ‘brake-by-wire’ operating mode on both vehicle axles by means of the pressure delivered by the pump 23 in case the high-pressure accumulator 21 fails.

Both types of actuation are assigned to a first fallback level or fallback operating mode.

A second fallback level or fallback operating mode, as shown schematically in FIG. 6, relates to a failure of the separating valve 11 that separates the wheel brakes 9, 10 associated with the rear axle from the first pressure chamber of the master brake cylinder 2. Separating valve 11 remains open upon failure so that both rear-axle brakes 9, 10—with pressure compensating valve 13 open, are acted upon by the pressure introduced into the master brake cylinder 2. Wheel brakes 7, 8 of the intact front axle are actuated now as before in the ‘brake-by-wire’ operating mode.

A third fallback level or fallback operating mode that is indicated schematically in FIG. 7 relates to failure of the separating valve 14 separating the wheel brakes 7, 8 associated with the front axle from the second pressure chamber of the master brake cylinder 2. Once a fault of this type is detected, while the separating valve 14 is still open, the pressure compensating valves 19, 13 will be closed and the wheel brakes 7, 8 and 9, 10 separated from each other. Separating valve 11 associated with the rear axle is opened simultaneously. The pressure control valves 17, 18, 27, 28, 37, 38, 47, 48 are then actuated so that brake pressure control is continued in the ‘brake-by-wire’ operating mode in a wheel brake 8 associated with the front axle and in a wheel brake associated with the rear axle, or the wheel brake 9 lying diagonally opposite the wheel brake 8, while the pressure control valves 17, 27, 37, 47 of the other two, diagonally opposite wheel brakes 7, 10 are closed so that the pressure introduced into the master brake cylinder 2 is applied to the wheel brakes 7, 10. The connecting line drawn between the wheel brakes 7 and 10 represents the hydraulic communication occurring within the master brake cylinder 2.

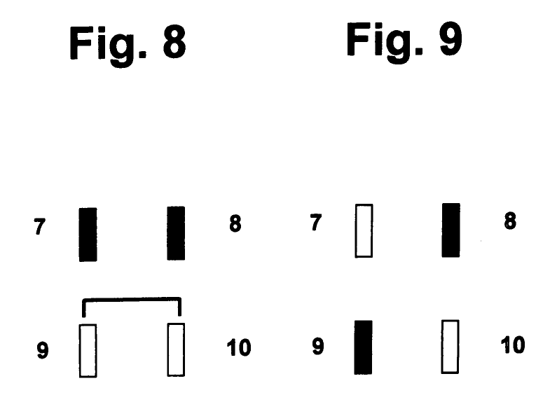

A fourth fallback level or fallback operating mode, which is represented in FIG. 8, is actuated when a loss in pressure is detected in any one of wheel brakes 9 or 10 associated with the rear axle. When such a fault occurs, the two wheel brakes 9, 10 are maintained in their non-pressurized condition by actuating the outlet valves 47, 48. Pressure control in the wheel brakes 7, 8 associated with the intact front axle is now as before executed in the “brake-by-wire” operating mode.

A fifth fallback level or fallback operating mode is represented in FIG. 9 and actuated when a loss in pressure is detected in any one of wheel brakes 7 or 8 associated with the front axle. When such a fault is detected, the pressure compensating valves 19, 13 will be closed and the wheel brakes 7, 8 as well as 9, 10 separated from one another. The pressure control valves 17, 18, 27, 28, 37, 38, 47, 48 are then actuated so that brake pressure control is continued in the ‘brake-by-wire’ operating mode in a wheel brake associated with the front axle, e.g. wheel brake 8, and in a wheel brake associated with the rear axle, e.g. wheel brake 9 lying diagonally opposite wheel brake 8, while the outlet valves 27, 48 of the other two, diagonally opposite wheel brakes 7, 10 are actuated so that the wheel brakes 7, 10 are maintained in their non-pressurized condition. Of course, the same actuation may also be performed in such a way that the wheel brakes 7, are activated in the ‘brake-by-wire’ mode, while the wheel brakes 8, 9 are maintained in their non-pressurized condition by actuating the associated outlet valves 28, 47.

1. Method for controlling an electrohydraulic brake system for motor vehicles which is controllable in a ‘brake-by-wire’ operating mode by the vehicle operator as well as irrespective of the vehicle operator and wherein, when a fault occurs, various fallback operating modes are initiated depending on the type of fault, with a request for braking being converted into wheel nominal brake pressures for the individual wheel brakes and the wheel brake pressure being adjusted to the wheel nominal brake pressure in consideration of a measured wheel brake pressure, and wherein pressure sensors are provided to determine the wheel brake pressures,
characterized in that in the event of failure of a pressure control or inlet/outlet valve (17, 18, 37, 38/27, 28, 47, 48) that is caused by a mechanical fault, the said valve controlling the wheel brake pressure in a wheel brake (7-10) associated with a vehicle axle, or in the event of failure of a pressure sensor (30, 31, 40, 41) that is associated with a wheel brake (7, 8 or 10, 9) of a vehicle axle, brake pressure control on this vehicle axle is carried out in the ‘brake-by-wire’ operating mode by means of an inlet valve (17 and/or 18 or 47 and/or 48) and an outlet valve (27 and/or 28 or 47 and/or 48) or by means of the pressure sensor associated with the other wheel brake of the vehicle axle, with the pressure compensating valve (19, 13) connected between the wheel brakes of the vehicle axle being open, while brake pressure control on the other vehicle axle is continued unchanged in the ‘brake-by-wire’ operating mode.

2. Method as claimed in claim 1,
characterized in that the inlet and the outlet valves (17, 18, 37, 38/27, 28, 47, 48) are designed as electromagnetically operable, normally closed proportional valves that remain closed upon failure of the electric actuation control.

3. Method for controlling an electrohydraulic brake system for motor vehicles which is controllable in a ‘brake-by-wire’ operating mode by the vehicle operator as well as irrespective of the vehicle operator and wherein, when a fault occurs, various fallback operating modes are initiated depending on the type of fault, and which includes an auxiliary pressure source comprised of a hydraulic motor-and-pump assembly and a high-pressure accumulator, wherein a request for braking is converted into wheel nominal brake pressures for the individual wheel brakes and the wheel brake pressure is adjusted to the wheel nominal brake pressure in consideration of a measured wheel brake pressure,
characterized in that the hydraulic motor-and-pump assembly (20) exclusively ensures the development of the wheel brake pressure on all wheel brakes (7-10) when the high-pressure accumulator (21) fails.

4. Method for controlling an electrohydraulic brake system for motor vehicles which is controllable in a ‘brake-by-wire’ operating mode by the vehicle operator as well as irrespective of the vehicle operator and wherein, when a fault occurs, various fallback operating modes are initiated depending on the type of fault, and which includes an auxiliary pressure source comprised of a hydraulic motor-and-pump assembly and a high-pressure accumulator, wherein a request for braking is converted into wheel nominal brake pressures for the individual wheel brakes and the wheel brake pressure is adjusted to the wheel nominal brake pressure in consideration of a measured wheel brake pressure,
characterized in that upon failure of the hydraulic motor-and-pump assembly (20), the development of wheel brake pressure on all wheel brakes (7 to 10) is exclusively effected by the high-pressure accumulator (21).

5. Method for controlling an electrohydraulic brake system for motor vehicles which is controllable in a ‘brake-by-wire’ operating mode by the vehicle operator as well as irrespective of the vehicle operator and wherein, when a fault occurs, various fallback operating modes are initiated depending on the type of fault, and which includes a master brake cylinder operable by means of a brake pedal and to which the wheel brakes are connected by the intermediary of at least one separating valve, wherein a request for braking is converted into wheel nominal brake pressures for the individual wheel brakes and the wheel brake pressure is adjusted to the wheel nominal brake pressure in consideration of a measured wheel brake pressure,
characterized in that brake pressure control on the front axle is continued unchanged in the ‘brake-by-wire’ operating mode upon failure of the separating valve (11) associated with the rear axle, while the wheel brakes (9, 10) associated with the rear axle are connected to the master brake cylinder (2).

6. Method for controlling an electrohydraulic brake system for motor vehicles which is controllable in a ‘brake-by-wire’ operating mode by the vehicle operator as well as irrespective of the vehicle operator and wherein, when a fault occurs, various fallback operating modes are includes a master brake cylinder operable by means of a brake pedal and to which the wheel brakes are connected by the intermediary of at least one separating valve, wherein a request for braking is converted into wheel nominal brake pressures for the individual wheel brakes and the wheel brake pressure is adjusted to the wheel nominal brake pressure in consideration of a measured wheel brake pressure,
characterized in that brake pressure control in a first wheel brake (7) of a vehicle axle as well as in the diagonally opposite wheel brake (9) of the other vehicle axle is continued in the ‘brake-by-wire’ operating mode upon failure of the separating valve (14) associated with the front axle, with the two pressure compensating valves (19, 13) connected between the wheel brakes (7, 8 and/or 9, 10) of both vehicle axles being closed, while the other diagonally opposite wheel brakes (7, 10) are connected to the master brake cylinder (2).

7. Method for controlling an electrohydraulic brake system for motor vehicles which is controllable in a ‘brake-by-wire’ operating mode by the vehicle operator as well as irrespective of the vehicle operator and wherein, when a fault occurs, various fallback operating modes are initiated depending on the type of fault, wherein a request for braking is converted into wheel nominal brake pressures for the individual wheel brakes and the wheel brake pressure is adjusted to the wheel nominal brake pressure in consideration of a measured wheel brake pressure,
characterized in that a loss in pressure fluid in a wheel brake (9 or 10) associated with the rear axle will cause both wheel brakes (9, 10) associated with the rear axle to maintain their non-pressurized condition, while brake pressure control in the wheel brakes (7, 8) associated with the front axle is continued in the ‘brake-by-wire’ operating mode.

8. Method for controlling an electrohydraulic brake system for motor vehicles which is controllable in a ‘brake-by-wire’ operating mode by the vehicle operator as well as irrespective of the vehicle operator and wherein, when a fault occurs, various fallback operating modes are initiated depending on the type of fault, wherein a request for braking is converted into wheel nominal brake pressures for the individual wheel brakes and the wheel brake pressure is adjusted to the wheel nominal brake pressure in consideration of a measured wheel brake pressure,
characterized in that a loss in pressure fluid in a wheel brake (7) associated with the front axle will cause said wheel brake (7) as well as the diagonally opposite wheel brake (10) of the rear axle to maintain their non-pressurized condition, with the two pressure compensating valves (19, 13) connected between the wheel brakes of the two vehicle axles being closed, while brake pressure control in the other diagonally opposite wheel brakes (8, 9) is continued in the ‘brake-by-wire’ operating mode.
